(19) United States
(12) Patent Application Publication
(10) Pub. No.: US 2007/0006621 A1
(43) Pub. Date: Jan. 11, 2007

(54) Key with identifier inserts

(76) Inventor: Shing-Hwa Doong, Taipei (TW)

Correspondence Address: BIRCH STEWART KOLASCH & BIRCH, PO BOX 747, FALLS CHURCH, VA, 22040-0747, US

(21) Appl. No.: 11/176,269

(22) Filed: Jul. 8, 2005

(51) Int. Cl. E05B 19/06

(52) U.S. Cl. 70/409

(57) ABSTRACT

A key with identifier inserts has a bow casing, a key blade, multiple identifier inserts and a replacement bar. The key blade is attached to the bow casing and has multiple holes. The identifier inserts are mounted respectively in the holes. The replacement bar is mounted on the key blade, extends into the bow casing and has multiple hole assemblies. The hole assemblies are formed through the replacement bar and correspond respectively to the holes in the key blade. Each hole assembly has a replacement hole, an operating hole and an interval. The replacement hole is bigger than a corresponding identifier insert for conveniently replacing the identifier inserts. The operating hole is smaller than a corresponding identifier insert and selectively aligns with the identifier insert to reveal the identifier insert. The interval separates the replacement hole and the operating hole and holds the identifier insert in the key blade.

### BACKGROUND OF THE INVENTION

1. Field of the Invention

The present invention relates to a key, especially to a key with identifier inserts.

2. Description of the Prior Arts

Keys are used to lock and unlock locks in doors, and each key is a key blade with unique serrations. To lock and unlock a specific lock, the key blade and the serrations must match the lock cylinder and pins of a specific lock. The lock that is opened and locked only with a key blade with matching serrations is easy to pick by burglars. Therefore, keys with identifier inserts were invented to lock and unlock electronic locks. A conventional key with identifier inserts comprises two key blades and multiple identifier inserts. The key blades are attached to each other and have multiple through holes formed through the key blades. The identifier inserts are mounted between the key blades in the through holes. The lock cylinder has an identifier device inside to recognize a specific pattern of identifier inserts. With the identifier device, the lock is hard to pick by burglars. However, the identifier inserts are not easy to replace because the identifier inserts are mounted between the key blades, and the key blades are attached securely to each other. Furthermore, the identifier inserts easily dislodge from the key blades if the key blades are not attached to each other well.

To overcome the shortcomings, the present invention provides an improved key with identifier inserts to mitigate or obviate the aforementioned problems.

### SUMMARY OF THE INVENTION

The main objective of the present invention is to provide a key with identifier inserts in which the identifier inserts are easily replaced and the identifier inserts are secured well in the key. The key with identifier inserts has a bow casing, a key blade, multiple identifier inserts and a replacement bar. The key blade is attached to the bow casing and has multiple holes formed through the key blade. The identifier inserts are mounted respectively in the holes. The replacement bar is mounted on the key blade, extends into the bow casing and has multiple hole assemblies. The hole assemblies are formed separately through the replacement bar and correspond respectively to the holes in the key blade. Each hole assembly has a replacement hole, an operating hole and an interval. The replacement hole is bigger than the identifier inserts and selectively aligns with the identifier insert to replace the insert. The operating hole is smaller than the identifier insert and selectively aligns with the identifier insert to reveal the identifier insert. The interval separates the replacement hole and the operating hole holds the identifier insert in the key blade.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a key with identifier inserts in accordance with the present invention;

FIG. 2 is an exploded perspective view of the key in FIG. 1;

FIG. 3 is a cross sectional side view of the key in FIG. 1;

FIG. 4 is an operational side view in partial section of the key in FIG. 1 when the key is inserted into a lock cylinder;

FIG. 5 is an operational partial exploded perspective view of the key in FIG. 1; and

FIG. 6 is an operational side view in partial section of the key in FIG. 1.

### DETAILED DESCRIPTION OF THE PREFERRED EMBODIMENTS

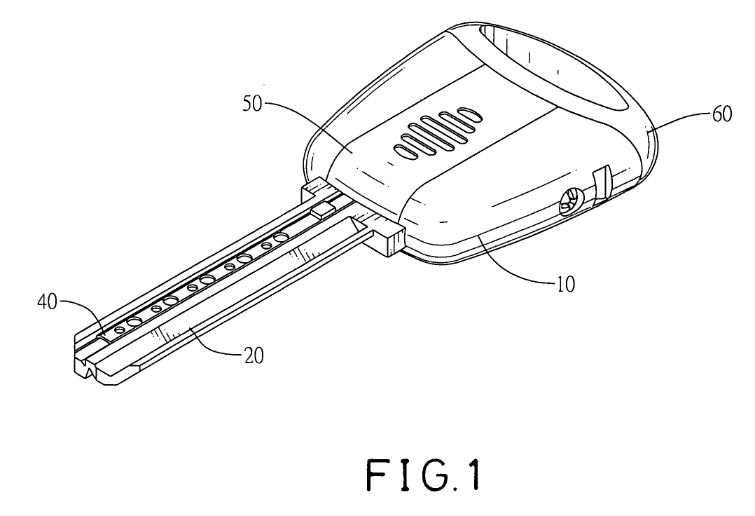

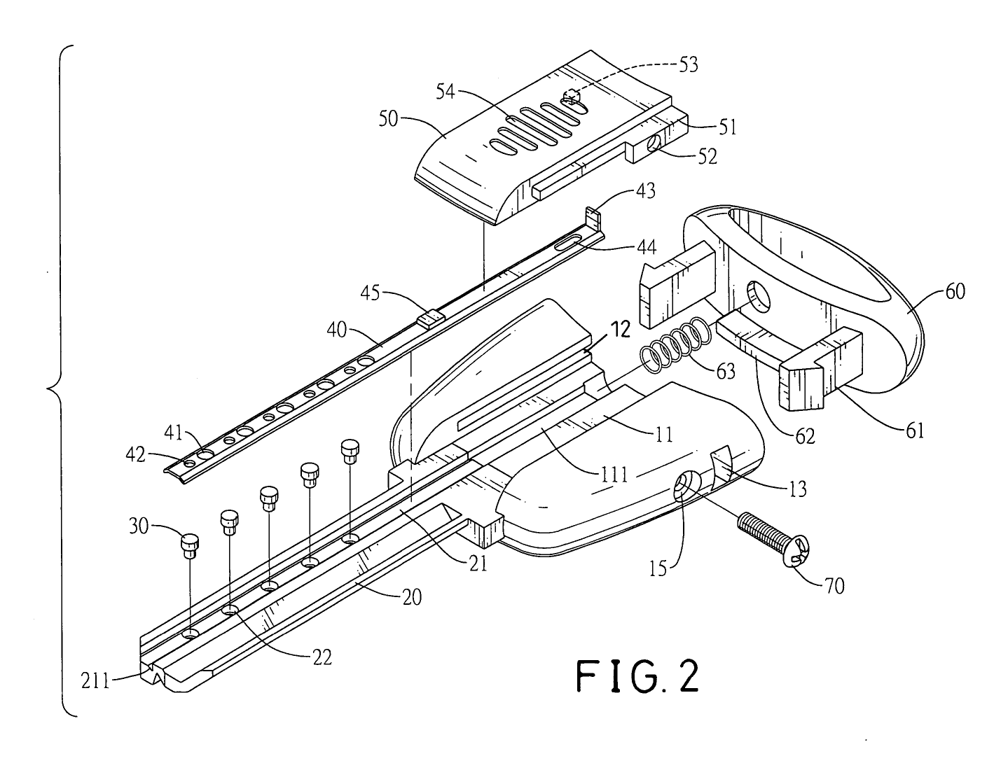

With reference to FIGS. 1 and 2, a key with identifier inserts in accordance with the present invention comprises a bow casing (10), a key blade (20), multiple identifier inserts (30), a replacement bar (40), a replacement tab (50), an optional end cap (60) and a tab lock (70).

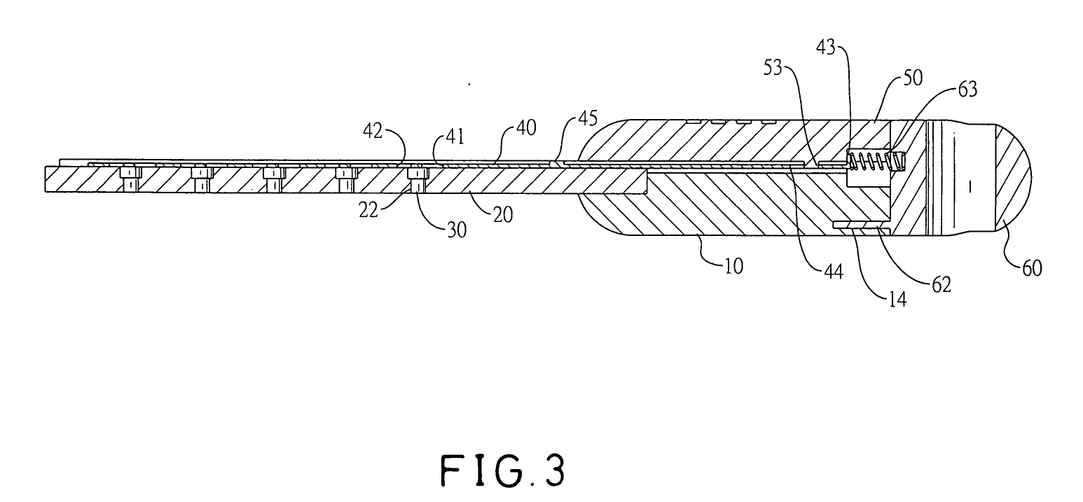

With further reference to FIG. 3, the bow casing (10) has a longitudinal side recess, a front end, a rear end, two opposite outside edges and a locking hole (15) and may have two L-shaped clip holes (13) and a mounting slot (14). The longitudinal side recess has a front opening and a rear opening and may have two opposite inside walls, two shoulders (11), a bar slot (111) and two guide slots (12). The shoulders (11) are formed respectively in the inside walls. The bar slot (111) is formed between the shoulders (11) in the longitudinal side recess. The guide slots (12) are formed respectively in the inside walls and communicate with the rear opening. The clip holes (13) are formed through the rear end and extend respectively toward the outside edges. The mounting slot (14) is formed in the rear end of the bow casing (10). The locking hole (15) is formed through one of the outside edges and communicates with the longitudinal side recess.

The key blade (20) is mounted in the front opening of the longitudinal side recess, may be adjacent to the shoulders (11) in the longitudinal side recess and has a side surface, a bar slot (21) and multiple holes (22). The bar slot (21) is formed longitudinally in the side surface of the key blade (20), aligns with the bar slot (111) in the longitudinal side recess and may have two sidewalls and two mounting grooves (211). The mounting grooves (211) are formed respectively in the sidewalls of the bar slot (21). The holes (22) are separately formed transversely through the key blade (20). Each hole (22) has a top opening communicating with the bar slot (21), which may be countersunk.

The identifier inserts (30) are mounted respectively in the holes (22) in the key blade (20) and may have an enlarged head corresponding to the countersunk top opening of the holes (22) through the key blade (20).

The replacement bar (40) is mounted slidably in the bar slot (21) in the key blade (20), extends into the bow casing (10), is mounted slidably in the bar slot (111) in the longitudinal side recess, extends into and slides in the mounting grooves (211) in the bar slot (21) and has a rear end, multiple hole assemblies, an optional positive stop (43), an optional longitudinally elongated hole (44) and an optional protrusion (45). The hole assemblies are formed separately through the replacement bar (40) and correspond respectively to the holes (22) in the key blade (20). Each hole assembly comprises a replacement hole (41), an operating hole (42) and an interval. The replacement hole (41) is bigger than the identifier insert (30) and the holes (22) in the key blade (20). The operating hole (42) is smaller than the replacement hole (41) and the identifier inserts (30). The interval separates the replacement hole (41) and the operating hole (42). The positive stop (43) is formed on and extends perpendicularly from the rear end of the replacement bar (40). The longitudinally elongated hole (44) is formed through the replacement bar (40) near the rear end and has a front end and a rear end. The protrusion (45) is formed on the replacement bar (40) between the hole assemblies and the longitudinally elongated hole (44).

The replacement tab (50) is mounted slidably in the longitudinal side recess in the bow casing (10), is attached to the replacement bar (40), has a front end, a rear end, a top surface, a bottom surface, two sidewalls and a detent (52) and may have two rails (51), a protrusion (53) and multiple flutes (54). The detent (52) is formed in the sidewall corresponding to the locking hole (15) in the outer edge of the bow casing (10) and corresponds to and aligns with the locking hole (15) in the bow casing (10) when the operating holes (42) align with the identifier inserts (30). The rails (51) are formed respectively on and protrude out from the sidewalls and are slidably mounted respectively in the guide slots (12) in the longitudinal side recess. The protrusion (53) is formed on the bottom surface and corresponds to and engages the longitudinally elongated hole (44) in the replacement bar (40). The flutes (54) are formed on the top surface of the replacement tab (50).

The end cap (60) is attached to the rear of the bow casing (10) and has a front surface, two resilient clips (61), a mounting tab (62) and a spring (63). The resilient clips (61) are formed on the front surface of the end cap (60) and correspond respectively to and engage the clip holes (13) in the bow casing (10). The mounting tab (62) is formed on the front surface of the end cap (50) and corresponds to and is mounted in the mounting slot (14) in the bow casing (10). The spring (63) is attached to the front surface of the end cap (60), aligns with the bar slot (111) in the bow casing (10) and presses against the positive stop (43) on the rear end of the replacement bar (40).

The tab lock (70) is mounted in the locking hole (15) in the bow casing (10) and extends into the detent (52) in the replacement tab (50) to hold the replacement tab (50) in position in the bow casing (10).

When the key is not used, the protrusion (53) on the replacement tab (50) abuts the rear end of the longitudinally elongated hole (44) in the replacement bar (40). Because the tab lock (70) holds the replacement tab (50) in the bow casing (10), the spring (63) cannot push the replacement bar (40) and the intervals in each hole assembly align respectively with the identifier inserts (30).

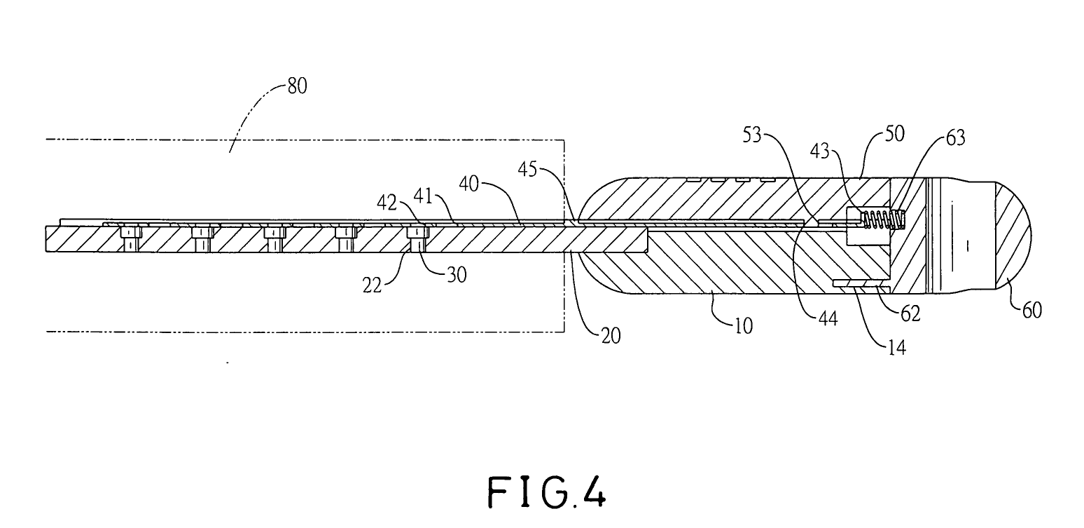

With further reference to FIG. 4, a lock cylinder (80) into which the key is inserted has a keyhole and an identifier device. The keyhole has an outer edge. When the key is inserted into the lock cylinder (80), the protrusion (45) on the replacement bar (40) abuts the outer edge of the keyhole and pushes the replacement bar (40) into the bow casing (10) until the operating holes (42) align respectively with the identifier inserts (30). Therefore the identifier device can identify the identifier inserts (30).

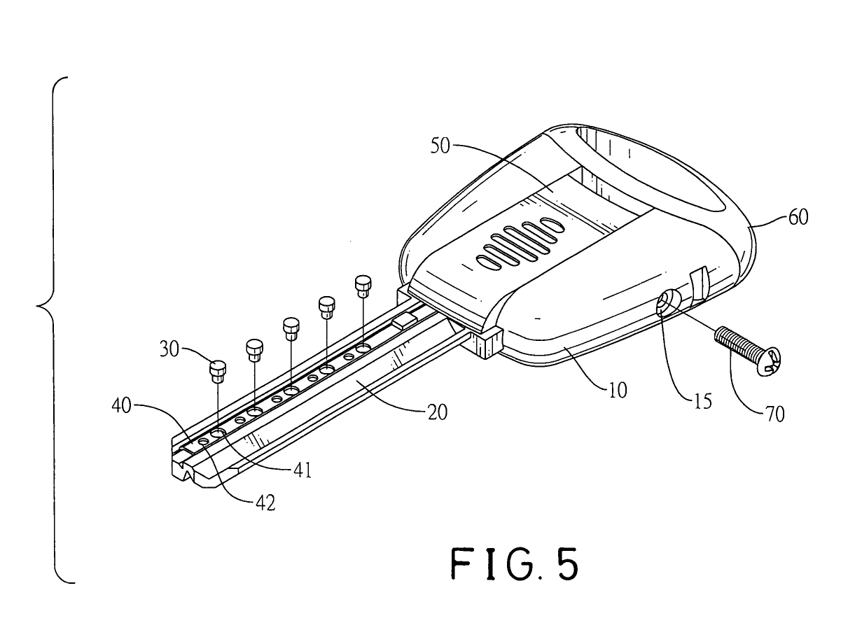

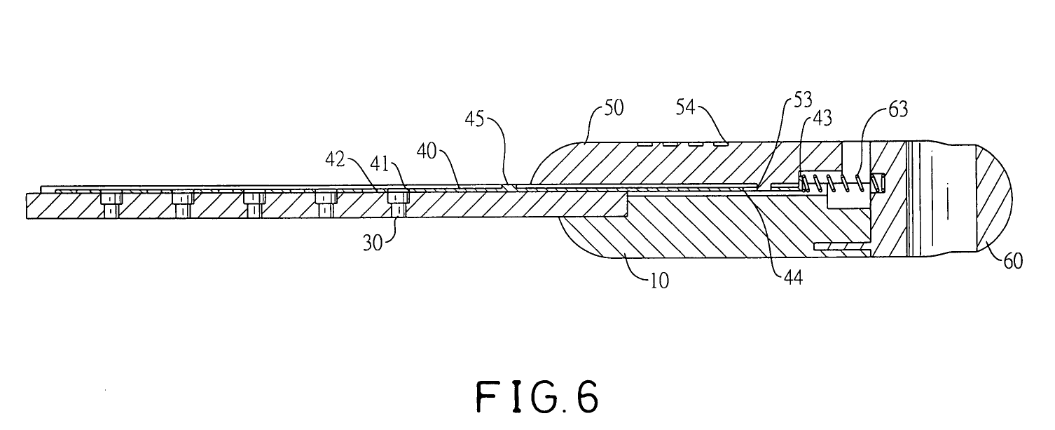

With further reference to FIGS. 5 and 6, the identifier inserts (30) are replaced by removing the tab lock (70) from the detent (52) in the replacement tab (50) and pushing the replacement tab (50) forward until the replacement holes (41) align with the identifier inserts (30). The identifier inserts (30) can be easily replaced.

The key as described has numerous advantages. The replacement bar (40) holds the identifier inserts (30) securely in the key blade (20). The identifier inserts (30) are replaced easily simply by removing the tab lock (70) from the detent (52) and pushing the replacement tab (50) forward to align the replacement holes (41) with the identifier inserts (30).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A key with identifier inserts comprising
a bow casing having
a longitudinal side recess having a front opening and a rear opening;
a front end;
a rear end;
two opposite outside edges; and
a locking hole formed through one of the outside edges and communicating with the longitudinal side recess;
a key blade mounted in the front opening of the longitudinal side recess and having
a side surface;
a bar slot formed longitudinally in the side surface of the key blade; and
multiple holes separately formed transversely through the key blade, and
each hole having a top opening communicating with the bar slot;
multiple identifier inserts mounted respectively in the holes in the key blade;
a replacement bar mounted slidably in the bar slot in the key blade, extending into the bow casing and having
a rear end; and
multiple hole assemblies formed separately through the replacement bar and corresponding respectively to the holes in the key blade, and each hole assembly comprising
a replacement hole bigger than a corresponding one of the identifier inserts to allow the corresponding identifier insert to pass through the replacement hole;
an operating hole smaller than a corresponding one of identifier inserts to keep the corresponding identifier insert from passing through the operating hole; and
an interval separating the replacement hole the operating hole;
a replacement tab mounted slidably in the longitudinal side recess in the bow casing, attached to the replacement bar and having
a front end;
a rear end;
a top surface;
a bottom surface;
two sidewalls; and
a detent formed in the sidewall and corresponding to and aligning with the locking hole in the bow casing; and
a tab lock mounted in the locking hole in the bow casing and extending into the detent in the replacement tab to hold the replacement tab in position in the bow casing.

2. The key as claimed in claim 1, wherein
the longitudinal side recess further has
two opposite inside walls;
two shoulders formed respectively in the inside walls; and
a bar slot formed between the shoulders in the longitudinal side recess;
the key blade is adjacent to the shoulders in the longitudinal side recess;
the bar slot in the key blade aligns with the bar slot in the longitudinal side recess;
the replacement bar is mounted slidably in the bar slot in the longitudinal side recess and has
a longitudinally elongated hole formed through the replacement bar near the rear end of the replacement bar and having a front end and a rear end; and
a protrusion formed on the replacement bar between the hole assemblies and the longitudinally elongated hole; and
the replacement tab has a protrusion formed on the bottom surface of the replacement tab and corresponding to and engaging the longitudinally elongated hole in the replacement bar.

3. The key as claimed in claim 2, wherein
the longitudinal side recess further has
two guide slots formed respectively in the opposite inside walls and communicating with the rear opening;
the bar slot in the key blade further has
two sidewalls; and
two mounting grooves formed respectively in the sidewalls of the bar slot;
the bow casing further has
two L-shaped clip holes formed through the rear end and extending respectively toward outside edges; and
a mounting slot formed in the rear end of the bow casing;
the replacement bar extends into and slides in the bar slots;
the replacement tab further has
two rails formed respectively on and protruding out from the sidewalls and slidably mounted respectively in the guide slots in the longitudinal side recess; and
the key further comprises
an end cap attached to the rear of the bow casing and having
a front surface;
two resilient clips formed on the front surface of the end cap and corresponding respectively to and engaging the clip holes in the bow casing;
a mounting tab formed on the front surface of the end cap and corresponding to and being mounted in the mounting slot in the bow casing; and
a spring attached to the front surface of the rear cover, aligning with the bar slot in the bow casing and pressing against the rear end of the replacement bar.

4. The key as claimed in claim 3, wherein
the replacement bar further has a positive stop formed on and extending perpendicular from the rear end of the replacement bar; and
the spring on the end cap presses against the positive stop on the rear end of the replacement bar.

5. The key as claimed in claim 1, wherein the replacement tab has multiple flutes formed on the top surface of the replacement tab.

6. The key as claimed in claim 4, wherein the replacement tab has multiple flutes formed on the top surface of the replacement tab.

7. The key as claimed in claim 1, wherein
the holes in the key blade are countersunk; and
each identifier insert has an enlarged head corresponding to the countersunk top opening of a corresponding hole through the key blade.

8. The key as claimed in claim 6, wherein
the holes in the key blade are countersunk; and
each identifier insert has an enlarged head corresponding to the countersunk top opening of a corresponding hole through the key blade.
